(19) United States
(12) Patent Application Publication
(10) Pub. No.: US 2025/0105934 A1
(43) Pub. Date: Mar. 27, 2025

(54) A METHOD FOR CHARACTERIZING RADIOFREQUENCY INTERFERENCE CAUSED BY A PLURALITY OF SOURCES, AN OBSERVING DEVICE, A SYSTEM, AND A COMPUTER PROGRAM

(71) Applicant: MITSUBISHI ELECTRIC CORPORATION, Tokyo (JP)

(72) Inventors: Viet Hoa NGUYEN, RENNES Cedex 7 (FR); Nicolas GRESSET, RENNES Cedex 7 (FR)

(73) Assignee: MITSUBISHI ELECTRIC CORPORATION, Tokyo (JP)

(21) Appl. No.: 18/727,128

(22) PCT Filed: Sep. 30, 2022
(86) PCT No.: PCT/JP2022/037526

§ 371 Date: Jul. 8, 2024

(30) Foreign Application Priority Data
Feb. 28, 2022 (EP) 22305221.8

(51) Int. Cl. H04B 17/345; H04B 17/354

(52) U.S. Cl. CPC H04B 17/345; H04B 17/354

(57) ABSTRACT

The disclosure relates to characterizing radiofrequency interference caused by a plurality of sources. At least one observing device is used for scanning successively a plurality of radiofrequency bands for performing interference measurements in the plurality of radiofrequency bands, in different space locations, and at different time instants, and provides observations at successive time instants of a current position of the observing device, and a received interference power in an observed frequency band. For each interference source and each observation, a likelihood probability to attribute one observation to one interference source is computed. This likelihood probability computations are used for assigning each of said observations to one interference source. More particularly, the likelihood probability computing is based on both frequency observation and interference power observation.

### TECHNICAL FIELD

The present disclosure is in the context of monitoring a radio environment.

### BACKGROUND ART

As many wireless communication systems nowadays operate in a public band, one must cope with the coexistence of interference. The characterization of interference helps monitoring the radio environment and/or managing the radio resource. In particular, it is sought for characterization of wireless interference.

Interference monitoring in a radio environment where multiple interference sources exist requires usually an analysis of observation obtained from several devices. The problem is rather more complex when the sources move during the observations. The problem is usually to identify the interference as separated sources and to characterize then the following properties for each source:
Operating frequency band,
Geolocation,
Activation rate.

The present disclosure aims to improve the situation.

### SUMMARY OF INVENTION

To that end, it proposes a method for characterizing radiofrequency interference caused by a plurality of sources, comprising:
using at least one observing device scanning successively a plurality of radiofrequency bands for performing interference measurements in said plurality of radiofrequency bands, in different space locations, and at different time instants, and providing observations at successive time instants of:
   a current observing frequency,
   a current position of the observing device, and
   received interference power in an observed frequency band,
computing, for each interference source and each observation, a likelihood probability to attribute one observation to one interference source,
using said likelihood probability computations to assign each of said observations to one interference source,
for each interference source assigned with one of said observations, estimating a location and a frequency occupation of said interference source,

More particularly, the aforesaid likelihood probability computing is based on both frequency observation and interference power observation.

It is proposed therefore to use both the frequency observations and, here in particular, the power observations to compute the likelihood probabilities, the power observations being related to the distance between the interference source and the observing device.

For example, the likelihood probability computing can involve a joint Bayesian inference of frequency observation and interference power observation. Alternatively, an Euclidean distance calculation approach can be used also.

In an embodiment, a database storing previous detections can be used. Typically, in an embodiment, the aforesaid likelihood probability computing can use such a database storing, for each source of said interference sources, at least data of a location of said interference source and data of an occupation of at least two radiofrequency bands by said interference source.

Typically, these stored data can be derived from previous observations. Therefore, said data of a location of the interference source can be a data of a past location of the source, and said data of an occupation of the interference source can be typically a data of a past frequency occupation by said source.

The aforesaid database can be updated after each assignation of an observation to one interference source, in view of a next iteration of the method.

Therefore, the use of the database storing data of previous identifications of interferers (location/frequency band(s) of interference) can facilitate a current determination of multiple sources of interference. Reversely, after a determination of interferers, the content of the database is preferably updated so that it can be used efficiently for a next future iteration of the method.

In a particular embodiment, for each interference source, the database can provide at least one of:
an average past position, and
a probability map of a discretized past position.

Therefore, the database can provide an average past position of a source, and more particularly this average can be weighted inversely as a function of at the date of determination of this source.

The average past position can be used in a context of a “hard decision” embodiment which is specified below, and the probability map can be used in a context of a “source sampling” embodiment explained below also, depending for example on a level of confidence of a current determination of a source of interference.

Moreover, for each interference source, the database can provide at least one of:
an average radiofrequency band past occupation, and
probability map of radiofrequency range past occupation.

The database can store, for each interference source, data of occurrences of previous observations which were already assigned to this interference source.

This information of previous observations associated to a source can help also for probability calculations of a current observation to be associated (or not) to this same source.

For a current observation, the likelihood probability of one of the interference sources to be related to said current observation is computed on the basis of a comparison between data of said database and data of said given observation, and the aforesaid comparison comprises a determination of:
a similarity degree between a level of radiofrequency power measured in the current observation and a closest level of radiofrequency power corresponding to a source, given by a past position of this source in said database relatively to the current position of the observing device; and
and a similarity degree between a radiofrequency band which is occupied in the current observation and a radiofrequency band which was occupied by a source according to said database.

Therefore, the likelihood probability is computed on the basis of two items which can finally correspond to one same source:
The current position of this source relatively to the observing device, which is given by the radiofrequency power of the signal received and measured by the observing device, and
The frequency band(s) where such a source is active.

In the aforesaid “hard decision” embodiment, the assignation of at least one observation to one interference source can comprise:
sorting the likelihood probabilities computed for each interference source to attribute said at least one observation to said interference source,
selecting the highest computed likelihood probability to assign said at least one observation to the interference source having the highest computed likelihood probability.

In this embodiment, the likelihood probabilities can be computed for example on the basis of Euclidian distance calculations of:
a distance between the observing device and a source, in a radiofrequency power domain (linked therefore to the space domain typically), and
a distance between a frequency band occupied by said source according to the database, and a frequency band where interference is measured according to said observation.

In the “source sampling” embodiment, the assignation of at least one observation to one interference source comprises:
sampling each source assignation based on a related computed likelihood probability, with an initial random draw followed by calculation iterations until successive samples converge to said related computed likelihood probability.

For example, in view to choose the “hard decision” embodiment or the “source sampling” embodiment, each likelihood probability can be compared to a threshold and:
if the computed likelihood probability is above said threshold, then the highest computed likelihood probability is selected to assign said at least one observation to the interference source having the highest computed likelihood probability (hard decision embodiment),
if the computed likelihood probability is above said threshold, then the source assignation is sampled until convergence (source sampling embodiment).

Regarding the observing device, in an embodiment, the observing device can move in successive known positions while said interference sources are assumed to be in fixed positions.

For example, the observing device can be installed in a moving vehicle, such as a train, having a known trajectory, or can simply be equipped with a GPS to know its successive current positions.

Alternatively, the aforesaid scanning of plurality of radiofrequency bands can be performed by at least three observing devices having known spatial positions (fixed positions for example), said spatial positions being not aligned, and the sources positions determination can be performed by triangulation over the three observing devices.

The present disclosure can also aim at an observing device comprising a computer circuit to perform the method as presented above.

It also aims at a system comprising at least three observing devices for performing the method.

It also aims at a computer program comprising instructions which, when the program is executed by a computer, cause the computer to carry out the method.

It also aims at a non-transitory computer storage medium, storing instructions code of such a computer program.

### BRIEF DESCRIPTION OF DRAWINGS

FIG. 1 shows the main steps of the analysis processing of interference.

FIG. 2a shows the setting of a moving observing device: in spatial domain.

FIG. 2b shows the setting of a moving observing device: in frequency domain.

FIG. 3a shows the setting of a plurality of observing devices: in spatial domain.

FIG. 3b shows the setting of a plurality of observing devices: in frequency domain.

FIG. 4a shows the interference activity in the frequency domain of interference sources.

FIG. 4b shows their true respective positions in spatial domain.

FIG. 5a shows the observation on a moving device respectively in the frequency domain via frequency hopping and in spatial domain via received power measurements.

FIG. 5b shows the observation on a moving device respectively in the frequency domain via frequency hopping and in spatial domain via received power measurements.

FIG. 6a shows the result of the implementation of the method with a moving device and with five interference sources active in different channels (five different colours or grey levels in FIG. 6a).

FIG. 6b shows the result of the implementation of the method with a moving device and with five interference sources active during different time periods.

FIG. 6c shows the result of the implementation of the method with a moving device and with five interference sources relatively to different positions of the moving device.

FIG. 6d shows the result of the implementation of the method with a moving device and with five interference sources having respective positions finally determined.

FIG. 7 shows an interference analysis device for performing the method described above.

### DESCRIPTION OF EMBODIMENTS

More details and advantages of the present disclosure will be understood when reading the following description of embodiments given below as examples, and will appear from the related drawings.

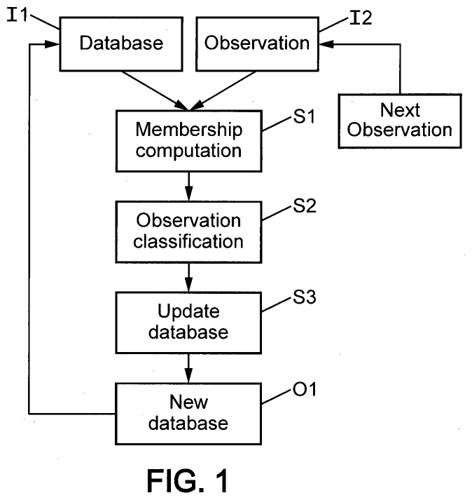

Referring to FIG. 1, given current observations I2 (mandatory) and an optional database I1 (the database can be built in prior steps of the method from precedent observations) of an environment comprising interferers for a communication system, the method proposes to analyse the interference in terms of frequency usage, geolocation characteristic and/or time usage. An interference analysis device performs observations in multiple frequencies, locations, and time instants.

The first input for each processing step is the interference database. For each separated current interference source, the database provides in step I1 the following information:
Position information, being either:
   The average position in considered space, or
   A probability map of a discretized position of considered space,
Frequency information, being either:
   The average frequency, or
   A probability map of considered frequency range,
Associated observations:
   Previous observations which were already assigned to the current interference source.

The aforesaid “current observations” can consist in step I2 of:
the position of the observing device (the aforesaid interference analysis device),
the received interference power, and
the observed frequency channel index.

Indeed, the interference analysis device scans a given frequency band over a plurality of radiofrequency channels (for example sixteen channels in the examples of the figures commented below), each channel having its proper index.

Then, step S1 comprises a membership computation. Using the database of interference sources, the likelihood of the current observations for each source is computed based on a Bayesian Inference. The calculation measures:
a similarity degree between a level of power given by the observation and a closest level of power of a source, given by a position of this source in the database; and
and a similarity degree between the frequency observation and the source's frequency database.

This probability reflects how strong the connection between an observation and a source is.

Then, step S2 comprises observation classification. Using the probability calculated in the previous step, step S1, the observation is assigned to a source. This step S2 can be performed according to several embodiments:
a “hard decision” embodiment where the assigned source is decided to be the one with highest probability, the decision being made once,
a “source sampling” embodiment where the source decision is sampled based on its estimated probability. This technique requires iterations to enable the samples to converge to the estimated probability.
A “hybrid method” embodiment where both the aforementioned methods are adopted, so as to balance the speed of the hard decision method and the stability of the source sampling method. Typically, a threshold of probability can be defined, above which the hard decision can be taken and below which the source sampling is rather used.

Then, step S3 comprises the database update. Once the observation is associated to a source, the database of this source evolves according to the observation and is updated thus accordingly.

Finally, in step O1, the newly updated database can be used in a next iteration of the process.

The details for each step of the general method are described below.

In the interfered radio environment, it is assumed that the interference is generated by one or several radio sources. One source distinguishes to another by its geometrical position and/or its operating frequency band.

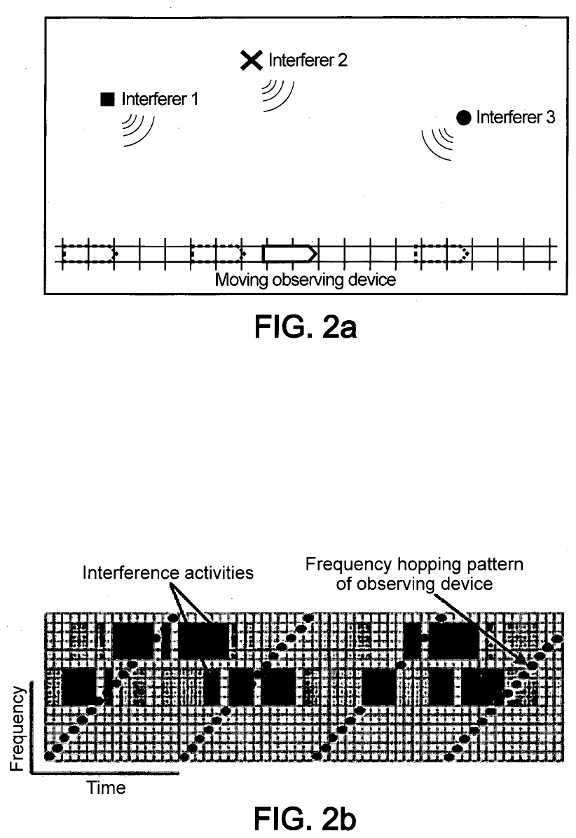

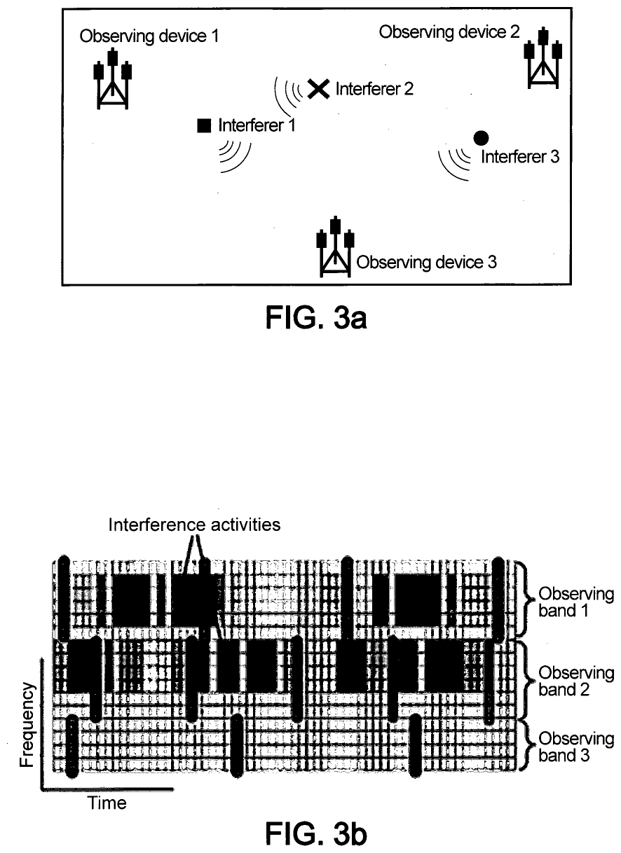

To be able to monitor the environment, the observation of interference is required. To that end, the observations can be obtained by any of the following devices:
One device with the capability of observing in multiple frequencies and in multiple locations: this device can be a wideband transceiver or a frequency-hoping transceiver, mounted on a moving vehicle (train, or car, or boat, etc.). An example for this setting is illustrated in FIG. 2a showing the change in the spatial domain, and in FIG. 2b showing the change in the frequency domain;
Or multiple devices with multiple operating frequency (possibly a wideband transceiver or a frequency-hoping transceiver): these devices are located in at least three non-aligned positions to enable the triangulation in geolocation. More than three positions are preferable to enhance the accuracy. An example of arrangement of devices in space and in frequency is shown respectively in FIGS. 3a and 3b.

For the observing device, since there does not exist any signalling exchange with interference sources, the interference transmission is completely random. In other words, the device blindly observes the interference without knowing the interference location. Therefore, the observation data can be seen as a mixed signal.

Hereafter the following notations are adopted:
Concerning an interference source Sₖ:
   k is the source's index
   θₖ is the source's position
   ϕₖ is the source's operating frequency
Concerning an observation Zₙ:
   n is the index of observation
   Tₙ is the position of observing device
   Wₙ is the received interference power
   Fₙ is the observed frequency.

For the estimation of the received power, it is assumed at the moment the observation Zₙ is obtained, that the interference source Sₖ is emitting. The received power (in dB for example) at the observing device can be modelled as

$${W}_{n} = a + blog ‖ {T}_{n} - {θ}_{k} ‖ + {ϑ}_{n , k} ,$$

where a and b are two coefficients of path-loss model and ϑ_{n,k} takes into account a possible shadowing. The shadowing follows the multivariate Gaussian distribution with the correlation between two vehicles' positions Tₙ and Tₘ (such as two trains' positions for instance) being expressed as:

$$ρ = {ρ}_{0} e \frac{‖ {T}_{n} - {T}_{m} ‖}{{d}_{c}}$$

where ρ₀, d_{c} are two coefficients of shadowing model.

The operating frequency of the interference source Sₖ can be modelled by two parameters:

$${ϕ}_{k} = ( {f}_{k} , {B}_{k} ) ,$$

where fₖ denotes the starting frequency and Bₖ denotes the band width.

To be able to analyse the interference, it is needed to classify the observations into separated sources. A database for each source then can be built and updated according to its belonged observations. This database afterward serves the next observation classification as a prior knowledge.

Hereafter, Vₙ denotes the latent variable which indicates the source that the observation Zₙ is assigned to. At the beginning of the analysis of observation Zₙ, the following statements are assumed:
(.)₋ₙ denotes the existing set of a variable before having the observation Zₙ
There exists K interference sources: k=1 . . . . K
For a source Sₖ, Z₋ₙ^{(k)} denotes the assigned observations
The database of source position is available under the form of probability as follows

$$p ( {θ}_{k} \vert {Z}_{- n}^{( k )} )$$

The database of source operating frequency is available under the form of probability as follows

$$p ( {ϕ}_{k} \vert {Z}_{- n}^{( k )} )$$

The membership computation of step S1 can be based either on:
a) Euclidean distance:
   Given the average position θ̅ₖ and average frequency \hat{ϕ}ₖ, the membership computation can be performed by the Euclidean distance between the observation and the interference source. In the spatial domain, the distance is proposed to be computed as follows

$${d}_{S} ( n , k ) = \vert {W}_{n} - a + blog ‖ {T}_{n} - {\overline{θ}}_{k} ‖ \vert ,$$

and the distance in the frequency domain is proposed to be computed as follows

$${d}_{F} ( n , k ) = \vert {F}_{n} - {\overline{ϕ}}_{k} \vert ,$$

b) Bayesian inference:
   In another approach, the membership computation can be proposed to be computed as corresponding to the probability that the observation can be a part of a source. Hereafter is denoted the latent variable Vₙ, corresponding to the time instant n, to indicate which source the observation belongs to. For an observation Zₙ=(Tₙ, Wₙ, Fₙ), the following probability can be considered

$$p ( {V}_{n} \vert {Z}_{n} , {Z}_{- n} , {V}_{- n} ) = \frac{p ( {Z}_{n} \vert {V}_{n} , {Z}_{- n} , {V}_{- n} ) \cdot p ( {V}_{n} \vert {Z}_{- n} , {V}_{- n} )}{p ( {Z}_{n} \vert {Z}_{- n} , {V}_{- n} )}$$

Since an interference source is independent to others, the likelihood probability p(Zₙ|Vₙ,Z₋ₙ, V⁻ⁿ) can be detailed for all possible values of Vₙ as

$$p ( {Z}_{n} \vert {V}_{n} , {Z}_{- n} , {V}_{- n} ) = {\int }_{{θ}_{{V}_{n}} , {ϕ}_{{V}_{n}}} p ( {Z}_{n} \vert {V}_{n} , {Z}_{- n}^{( {V}_{n} )} , {θ}_{{V}_{n}} , {ϕ}_{{V}_{n}} ) p ( {θ}_{{V}_{n}} \vert {Z}_{- n}^{( {V}_{n} )} ) p ( {ϕ}_{{V}_{n}} \vert {Z}_{- n}^{( {V}_{n} )} ) .$$

Due to the fact that the power observation Wₙ is a function of distance between the device and the interferer, it has no connection with the frequency observation Fₙ which simply depends on the setting of the device. The probability in previous equation can be thus rewritten as:

$$p ( {Z}_{n} \vert {V}_{n} , {Z}_{- n} , {V}_{- n} ) = {\int }_{{θ}_{V n}} p ( {W}_{n} \vert {V}_{n} , {W}_{- n}^{( {V}_{n} )} , {θ}_{{V}_{n}} ) p ( {θ}_{{V}_{n}} \vert {Z}_{- n}^{( {V}_{n} )} ) {\int }_{{θ}_{{V}_{n}}} p ( {F}_{n} \vert {V}_{n} , {F}_{- n}^{( {V}_{n} )} , {θ}_{{V}_{n}} ) p ( {θ}_{{V}_{n}} \vert {Z}_{- n}^{( {V}_{n} )} ) .$$

As mentioned above, the power observation (in dB for instance) follows the gaussian distribution. Therefore the probability p(Wₙ^{(V}^{ₙ}⁾|W₋ₙ^{(V}^{ₙ}⁾,θ_{V}_{ₙ}) can be expressed as:

$$p ( {W}_{n}^{( {V}_{n} )} \vert {W}_{- n}^{( {V}_{n} )} , {θ}_{{V}_{n}} ) = \frac{1}{\sqrt{2 π {σ}_{n \vert - n}^{{( {V}_{n} )}^{2}}}} {e}^{- \frac{{( {W}_{n} - {μ}_{n \vert - n}^{( {V}_{n} )} )}^{2}}{2 {σ}_{n \vert - n}^{{( {V}_{n} )}^{2}}}}$$

In this expression, the terms μ_{n|-n}^{(V}^{ₙ}⁾ and σμ_{n|-n}^{(V}^{ₙ}⁾ can be calculated as nl-n follows:

$$\{ \begin{matrix}{μ}_{n \vert - n}^{( {V}_{n} )} = {μ}_{n}^{( {V}_{n} )} + {\sum }_{n \vert - n}^{( {V}_{n} )} {\sum }_{- n}^{{( {V}_{n} )}^{- 1}} ( {W}_{- n}^{( {V}_{n} )} - {μ}_{- n}^{( {V}_{n} )} ) \\ {σ}_{n \vert - n}^{{( {V}_{n} )}^{2}} = {σ}^{2} - {\sum }_{n \vert - n}^{( {V}_{n} )} {\sum }_{- n}^{{( {V}_{n} )}^{- 1}} {\sum }_{- n \vert n}^{( {V}_{n} )}\end{matrix} ,$$

where:
   μₙ^{(V}^{ₙ}⁾ denotes a mean in a gaussian distribution for the observation Wₙ, and expressed as μₙ^{(V}^{ₙ}⁾=a+b log∥Tₙ−θ_{V}_{ₙ}∥
   Σ_{n|-n}^{(V}^{ₙ}⁾ denotes a correlation matrix between observation n and the other observation than n of source Vₙ,
   Σ₋ₙ^{(V}^{ₙ}⁾ denotes an auto-correlation matrix of observations other than n of source Vₙ,
   μ₋ₙ^{(V}^{ₙ}⁾ denotes the mean at observations other than n of source Vₙ,
   Σ_{-n|n}^{(V}^{ₙ}⁾ denotes the correlation matrix between observations other than n and observation n of source Vₙ.

The probability in frequency observation can be divided into two terms p₁, and p₂ as p(Fₙ∥F₋ₙ^{(k)}, ϕₖ)=p₁(Fₙ,ϕₖ)·p₂(Fₙ,ϕₖ). The design of p₁, and p₂ can be proposed as follows:
p₁ to indicate whether Fₙ is inside ϕₖ

$${p}_{1} = \{ \begin{matrix}1 & if ( {F}_{0}^{( k )} - {f}_{n} ) ( {F}_{0}^{( k )} + {B}^{( k )} - 1 - {f}_{n} ) \leq 0 \\ 0 & if ( {F}_{0}^{( k )} - {f}_{n} ) ( {F}_{0}^{( k )} + {B}^{( k )} - 1 - {f}_{n} ) > 0\end{matrix}$$

p₂ to determine how the fit is between the set of assigned frequencies F₋ₙ^{(k)}, together with Fₙ and ϕₖ. The better they fit, the bigger p₂ is. This term can be proposed as

$${p}_{2} = α \frac{\vert \{ {F}_{n} , {F}_{- n} \} ⋂ {ϕ}_{k} \vert}{\vert \{ {F}_{n} , {F}_{- n} \} ⋃ {ϕ}_{k \vert}} ,$$

where α is a normalizing coefficient which makes the probability sum to one.

Then, for the implementation of step S2, the observation classification can be based then either on:
a) Euclidean distance
   The observation is classified by a hard decision according to its distance to the sources. In this sense, the observation is associated to the source with smallest distance, such as:

$${V}_{n} = {arg min}_{k} ( {d}_{S} ( n , k ) + {d}_{K} ( n , k ) )$$

b) Bayesian inference
   The observation classification can be derived by one of the following methods:
      Hard decision:
         The decision is made once according to the best membership probability

$${V}_{n} = {arg max}_{{V}_{n}} p ( {V}_{n} \vert {Z}_{n} , {Z}_{- n} , {V}_{- n} )$$

Sampling method:
   A random sample of Vₙ is drawn according to the membership probability p(Vₙ|Zₙ, Z₋ₙ, V₋ₙ). This approach requires iterations over the sampling which allow then the value of Vₙ to converge.
Hybrid approach:
   In order to adopt the advantage of two both aforementioned methods, the rapidity of the “hard decision” method and the stability of the sampling method, a hybrid approach is proposed below.
   First, the membership probability is normalized as follows

$$\overline{p} ( {V}_{n} \vert {Z}_{n} , {Z}_{- n} , {V}_{- n} ) = \frac{p ( {V}_{n} \vert {Z}_{n} , {Z}_{- n} , {V}_{- n} )}{{\sum }_{k} p ( {V}_{n} = k \vert {Z}_{n} , {Z}_{- n} , {V}_{- n} )}$$

Second, a threshold for the normalized membership probability is defined. In the present case, the best normalized membership probability falls above this threshold, and it can be stated that the best source for the observation is evident, so that the hard decision method can be implemented. For the other cases, the best source is ambiguous, thus the sampling method should rather be implemented.

The database update of step S3 can be based either on:
a) Euclidean distance
   Supposing that the observation Zₙ is associated to the source k, then the average position and frequency can be updated as follows:

$$\{ \begin{matrix}{\overline{θ}}_{k} = {arg min}_{{\overline{θ}}_{k}} {\sum }_{n i n source k} {d}_{S} ( n , k ) \\ {\overline{ϕ}}_{k} = {arg min}_{{\overline{ϕ}}_{k}} {\sum }_{n i n source k} {d}_{F} ( n , k )\end{matrix}$$

b) Bayesian inference
   For the geolocation database, the following probability is computed for the update:

$$p ( {θ}_{k} \vert {W}_{- n}^{( k )} , {W}_{n}^{( k )} ) = \frac{p ( {W}_{n}^{( k )} \vert {Z}_{- n}^{( k )} , {θ}_{k} ) p ( {θ}_{k} \vert {W}_{- n}^{( k )} )}{P ( {W}_{n}^{( k )} \vert {W}_{- n}^{( k )} )}$$

For the frequency database, the following probability is computed for the update

$$p ( {ϕ}_{k} \vert {F}_{n}^{( k )} , {F}_{- n}^{( k )} ) = \frac{p ( {F}_{n}^{( k )} \vert {F}_{- n}^{( k )} , {ϕ}_{k} ) p ( {ϕ}_{k} \vert {F}_{- n}^{( k )} )}{p ( {F}_{n}^{( k )} \vert {F}_{- n}^{( k )} )}$$

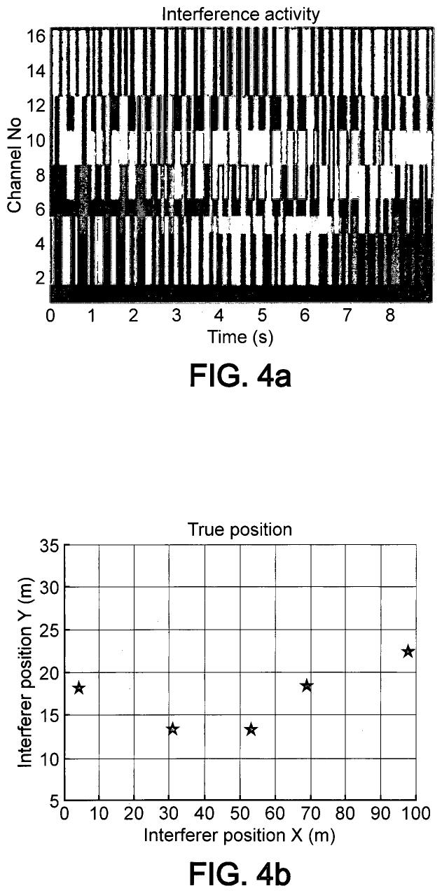

FIGS. 4a and 4b show an example of an interference environment. The interference activities in the frequency domain is depicted in FIG. 4a and the respective geographical positions of interferers are shown in FIG. 4b.

In this interfering environment, a moving device observes the interference environment via a frequency hopping (FH) pattern, as presented typically in FIG. 2b for instance. Details of such interference observations can be obtained for example from document EP-3716506.

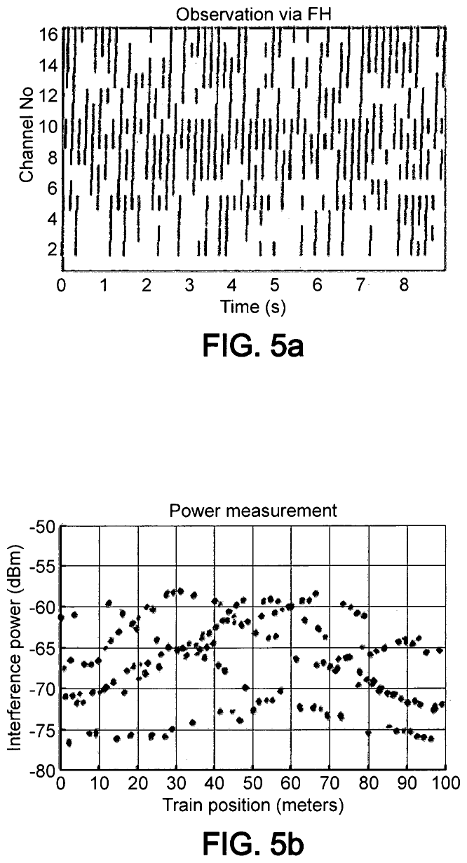

The initial corresponding observations obtained on the moving device are showed in FIG. 5a (in the frequency domain) and in FIG. 5b (in the spatial domain).

To analyse the environment, the Bayesian inference is used for the membership computation and the hard decision is used for the classification, in this example. The estimation is performed from scratch without any initial database.

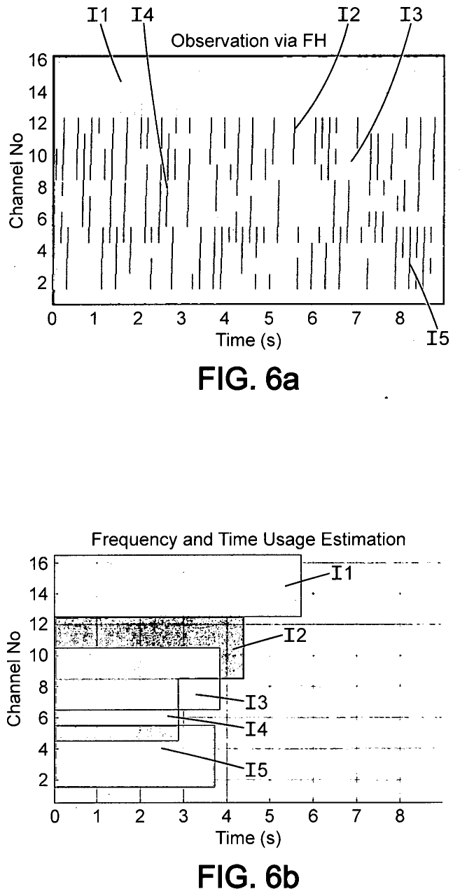

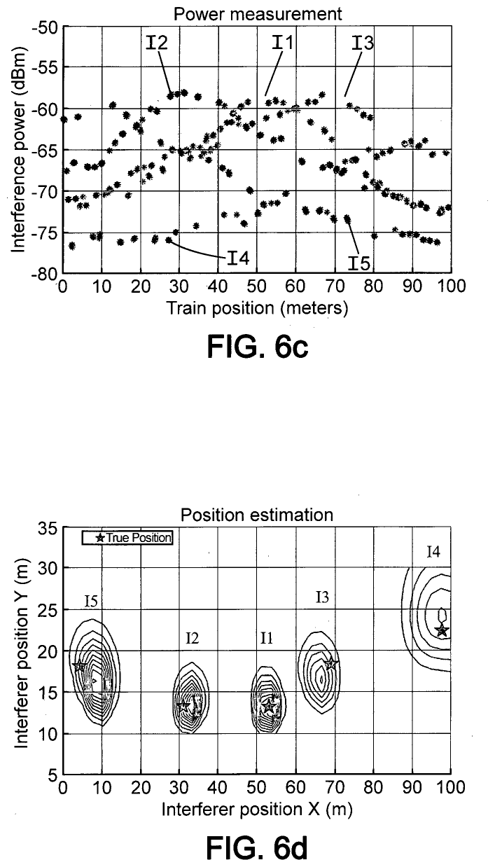

The result of observation classification is showed in FIG. 6a and FIG. 6c in the frequency domain and received power domain, respectively. In both figures, each label I1, I2, I3, I4 and I5 represents an interference source. As it can be seen, the method implementation makes it possible to estimate five interference sources and attribute the observations to each one of them. In FIG. 6b, the estimation of operation frequency and activation time are plotted for each interference source. In FIG. 6d, the contours of probability for the source's position resulted from the Bayesian update, are displayed along with the true position of the interference sources.

Therefore, the present disclosure allows the usage of a frequency hopping system, for instance in 2.4 GHz ISM band, for characterizing the interference along a predefined trajectory such as a railroad, thereby making it possible to reduce the impact of such interference for railways equipment and/or communicating devices embarked in a train.

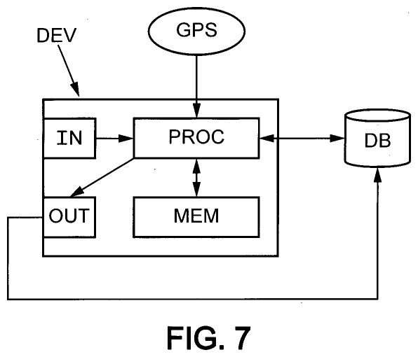

With reference to FIG. 7, a device DEV for implementing the method above can comprise for example:
An input interface IN (such as for example a radiofrequency antenna) to receive radiofrequency signals and measure radiofrequency power in each frequency channel according to a frequency hopping pattern as presented in FIG. 2b for instance,
A memory MEM to store at least instructions of a computer program to implement the method presented above, and possibly also to store data of the database DB used in the method,
A processor PROC accessing to said memory MEM and database DB so as to implement the method and finally determine current interference sources (positions and radiofrequency active bands),
An output interface OUT to deliver data of such a determination, that can feed the database DB so as to update its content,
And optionally in an embodiment where the device DEV is mobile, a GPS chip to determine the exact location of the device at each of its observations.

1. A method for characterizing radiofrequency interference caused by a plurality of sources, comprising:
using at least one observing device scanning successively a plurality of radiofrequency bands for performing interference measurements in said plurality of radiofrequency bands, in different space locations, and at different time instants, and providing observations at successive time instants of:
a current observing frequency,
a current position of the observing device, and
a received interference power in an observed frequency band,
computing, for each interference source and each observation, a likelihood probability to attribute one observation to one interference source,
using said likelihood probability computations to assign each of said observations to one interference source,
for each interference source assigned with one of said observations, estimating a location and a frequency occupation of said interference source,
Wherein said likelihood probability computing is based on both frequency observation and interference power observation.

2. The method of claim 1, wherein said likelihood probability computation uses a database storing, for each source of said interference sources, at least data of location of said source and data of occupation of at least two radiofrequency bands by said source.

3. The method of claim 2, wherein said database is updated after each assignation of an observation to one interference source, in view of a next iteration of the method.

4. The method according to claim 2, wherein, for each interference source, said database provides at least one of:
an average past position, and
a probability map of a discretized past position.

5. The method according to claim 2, wherein, for each interference source, said database provides at least one of:
an average radiofrequency band past occupation, and
probability map of radiofrequency range past occupation.

6. The method according to claim 2, wherein said database stores, for each interference source, data of occurrences of previous observations which were already assigned to said interference source.

7. The method according to claim 2, wherein, for a current observation, the likelihood probability of one of the interference sources to be related to said current observation is computed on the basis of a comparison between data of said database and data of said given observation, and wherein said comparison comprises a determination of:
a similarity degree between a level of radiofrequency power measured in the current observation and a closest level of radiofrequency power corresponding to a source, given by a past position of this source in said database and a current position of the observing device; and
and a similarity degree between a radiofrequency band which is occupied in the current observation and a radiofrequency band which was occupied by a source according to said database.

8. The method according to claim 1, wherein the assignation of at least one observation to one interference source comprises:
sorting the likelihood probabilities computed for each interference source to attribute said at least one observation to said interference source,
selecting the highest computed likelihood probability to assign said at least one observation to the interference source having the highest computed likelihood probability.

9. The method of claim 8, wherein the likelihood probabilities are computed on the basis of Euclidean distance calculations of:
a distance between the observing device and a source, in a radiofrequency power domain, and
a distance between a frequency band occupied by said source according to the database, and a frequency band where interference is measured according to said observation.

10. The method according to claim 1, wherein the assignation of at least one observation to one interference source comprises:
sampling each source assignation based on a related computed likelihood probability, with an initial random draw followed by calculation iterations until successive samples converge to said related computed likelihood probability.

11. The method according to claim 10, wherein each likelihood probability is compared to a threshold and:
if the computed likelihood probability is above said threshold, then the highest computed likelihood probability is selected to assign said at least one observation to the interference source having the highest computed likelihood probability,
if the computed likelihood probability is below said threshold, then the source assignation is sampled until convergence.

12. The method according to claim 1, wherein said observing device moves in successive known positions while said interference sources are assumed to be in fixed positions.

13. The method according to claim 1, wherein said scanning of plurality of radiofrequency bands is performed by at least three observing devices having known spatial positions, said spatial positions being not aligned, and wherein sources positions determination is performed by triangulation over the three observing devices.

14. The method according to claim 1, wherein said likelihood probability computing involves a joint Bayesian inference of frequency observation and interference power observation.

15. An observing device comprising a computer circuit to perform the method as claim 1.

16. A system comprising at least three observing devices for performing the method as claim 1.

17. A computer program comprising instructions which, when the program is executed by a computer, cause the computer to carry out the method according to claim 1.
